(19) United States
(12) Patent Application Publication
(10) Pub. No.: US 2025/0058549 A1
(43) Pub. Date: Feb. 20, 2025

(54) CAP LAYERS OF COMPOSTABLE MULTI-LAYER FILM

(71) Applicant: TORAY PLASTICS (AMERICA), INC., North Kingstown, RI (US)

(72) Inventors: Shichen DOU, North Kingstown, RI (US); Joshua R. CLOUTIER, North Kingstown, RI (US)

(21) Appl. No.: 18/449,067

(22) Filed: Aug. 14, 2023

(51) Int. Cl. B32B 27/08; B29C 48/00; B29C 48/21; B32B 27/20; B32B 27/22; B32B 27/36

(52) U.S. Cl. CPC B32B 27/08; B29C 48/022; B29C 48/21; B32B 27/20; B32B 27/22; B32B 27/36; B29C 48/0018; B29C 55/143; B29K 2067/046; B32B 2250/03; B32B 2250/244; B32B 2250/40; B32B 2270/00; B32B 2307/31; B32B 2307/406; B32B 2307/414; B32B 2307/518; B32B 2307/54; B32B 2307/704; B32B 2307/7163; B32B 2307/7376; B32B 2307/746; B32B 2439/46; B32B 2439/70

(57) ABSTRACT

A coextruded multi-layer compostable film comprises a core layer, a first cap layer and a second cap layer. The core layer comprises PLA resin, PHA resin and modifier X. The modifier X comprises migratory additives such as slip agents, nucleating agent, plasticizers, hydrolytic promoters, enzymes and fillers or mixtures thereof. The cap layers comprise at least 60 wt % TUV-certified home compostable composition. The content of migratory components in the cap layers is less than 0.5 wt % of the total weight of the cap layer, more preferably, less than 0.1 wt % of the total weight of the cap layer, more preferably, no migratory additives in the cap layers. The first cap layer has direct contact to the surface of the first chilled drum and the second cap layer has direct contact to the surface of the second chilled drum. In casting of a film, plate-out does not form on the surface of the chilled drums. The cap layers effectively prevent forming plate-out on the surface of processing equipment.

### FIELD OF THE INVENTION

This invention relates to cap layers of a multi-layer compostable composite film to prevent plate-out of low molecular weight components on processing equipment during thermal processing.

### BACKGROUND OF INVENTION

In recent years, interest in “Greener” packaging and “End of Life” has been strongly developing. Packaging materials based on biologically derived polymers are increasing due to concerns with plastic pollution, renewable resources, raw materials, and greenhouse gas generation. Bio-based plastics are believed to help reduce reliance on petroleum, reduce production of greenhouse gases, and eliminate plastic pollution, and can be biodegradable or compostable as well.

Bio-based plastics such as polylactic acid (PLA) and polyhydroxyalkanoates (PHA) derived from a renewable resource are the most popular and commercially available for packaging film applications. Polybutylene succinate (PBS) or Polybutylene succinate-co-adipate (PBSA) is a partially bio-based biodegradable polymer. Other biodegradable polymers such as poly (e-caprolactone) (PCL) and polybutylene adipate terephthalate (PBAT) that are petroleum-based biodegradable polymers are largely available at the time of this writing to address the concerns of plastics pollution and “End of Life” of disposable single use packaging.

PLA resins are suitable to make oriented polylactic acid films with a high clarity and high gloss as well as high modulus, which are very desirable for printing graphics with high visual appearance and for forming rigid container such as stand pouches of a single materials packaging. One example could be a two-layer coextruded film structure in which a base or core layer including a crystalline PLA and a thinner “skin” layer including amorphous PLA is coextruded upon one side of the core layer and then biaxially oriented into a film. The amorphous PLA layer is often used to provide heat scalability to the film as it is non-crystalline; it has a glass transition temperature (Tg) of 56° C. to 60° C. much lower than the melting temperature of the semi-crystalline PLA resins in the core layer. PLA is the most inexpensive biodegradable polymer obtained from renewable source.

A couple obvious disadvantages of this conventional BOPLA packaging have been noted in the marketplace since it was commercialized. Firstly, BOPLA packaging due to its very high modulus results in extremely loud noise at about 95 decibels, which is harmfully loud and potentially damages car hearing, compared to the noise level about 79 decibels for a conventional BOPP film packaging. Secondly, BOPLA packaging is only industrial compostable (ASTM D 5338-15, 58° C.), this approach has a drawback due to the constraints in public available facilities for composting.

Therefore, PLA resins need to be modified with flexible materials and plasticizers for better flexibility and modified with hydrolytic and enzymatic additives for faster compostability as well as home compostability. It is needed to develop a new food packaging using non-conventional composite materials so that food waste as well as food packaging together can compost under lower temperatures or in a shorter period of composting time. Home composting can be conducted in the backyard available for most of consumers in North America.

Polyhydroxyalkanoates (PHAs) are a group of renewable biodegradable polyesters that are synthesized by mainly microorganisms from renewable sources including sugars obtained from lignocellulosic biomasses, agricultural wastes, starches, and vegetable oils; PHAs are completely biodegradable and converted into CO2 and H2O in soil and oceans. PHAs are certified compostable bioplastics that could be used for making compostable food packaging films.

However, PHA resins have a few disadvantages including their poor mechanical properties, poor thermal stability, long crystallization time, high production cost as well as incompatibility with conventional thermal processing techniques have limited their competition with traditional synthetic plastics or their application as ideal bioplastics. To overcome these drawbacks, PHA resins must be modified to meet the performance required for specific applications. PHA resins can be modified using nucleating agents to increase the speed of crystallization, and using slip agents, lubricants, and plasticizers to improve its flowability inside processing equipment (e.g. extruder and die) so that processing temperature can be reduced to preventing from thermal degradation. PHA resins can also be modified by using other biodegradable polymers including PLA, PLA copolymers, PCL, PBAT, PBS, PBSA, chemically modified starch, cellulose derivatives, and different PHA-type blends and mixtures thereof.

It has been well noted that low molecular weight components used to modify either PLA resins for improving flexibility or compostability; or PHA resins for improving processability are polar molecules, which are migratable. Biopolymer compositions containing low molecular weight components, during processing, present the deposition of low molecular weight molecules in the forms of buildup and coated white powder on the surface of processing equipment through the direct contact or the migration of low molecular weight components. The deposition of low molecular weight components is so-called as the plate-out of the biopolymer composition, which interferes with proper operation of the equipment. Plate-out is unacceptable in production, which results in downtime and quality problem. For example, as plate-out on the chill-rolls occurs in the casting of making sheets or films, the production line needs to be shut down to clean the surface of the chill-rolls.

USPTO Pub. No.:US20210277226A1 describes a biodegradable composition (PLA-rich composition) comprising PLA resins, plasticizers, compatibilizers, and enzymes. Lactic acid oligomers (LAO) and compatibilizers significantly increase the tear resistance and elongation at break of bioplastic films. Enzymes well dispersed into PLA resins can improve PLA-biodegrading activity. All inventive PLA-based film articles show high toughness and high depolymerization rate. Higher degradation rate could indicate that enzymes in the presence promote the biodegradation of PLA resin. The enzymes and other low molecular weight components added into the polymeric composition directly contact the surface of the processing equipment, resulting in plate-out of low molecular weight components.

USPTO Pub. No.:US20230193021A1 describes a PLA-rich biodegradable resin composition produced by the method of TORAY NANOALLOY™ TECHNOLOGY comprising at least 70 wt % polylactic acid resin; and 5 to 29.9 wt % biodegradable polymers selected from the biopolymers of PCL, PBS, PBAT. PHA, poly(propylene carbonate) (PPC) and poly(glycolic acid) (PGA) or mixture thereof; and 0.1 to 10 wt % aliphatic carboxylic acids as well as an amount of 50 to 500PPM metal elements. It is disclosed that the PLA-rich biodegradable composition was coextruded and then biaxially oriented into a 20 μm thick film, the invented film showed significant improvement in biodegradability under home composting test condition (following ASTM5338-15 test procedures except for that the test temperature is 28° C.). However, the aliphatic carboxylic acids used to improve the hydrolysis of PLA resin in composting is highly migrative, the direct contact or migration results in plate-out of the low molecular weight component on the chill-roll in film casting.

USPTO Pub. No.:US2020033649A1 describes a biodegradable polymeric composition comprising 5 wt % to 95 wt % PHA resin and about 5 wt % to 95 wt % at least one biodegradable polymer selected from PBS, PBSA, PLA, PBAT, PCL, thermoplastic starch (TPS), cellulose esters, and mixture thereof; Nucleating agent was added into the polymeric composition at an amount of 0.1 to 5 wt %. Further, plasticizers can be incorporated into the biodegradable polymeric composition at an amount of 5 to 15 wt %. The biodegradable composition is both industrial and home compostable, and suitable for the application of making packaging articles. However, the invention does not demonstrate how to prevent from the plate-out resulted from the direct contact or the migration of low molecular weight components such as slip agents, nucleating agents and plasticizers in the casting of making a film.

### SUMMARY OF INVENTION

It is necessary to develop home compostable compositions without containing low molecular weight components or migratory additives as the cap layers of either PLA-rich or PHA-rich compostable polymeric compositions which are used in the core layer of a sheet or a film so that plate-out resulted from direct contact or migration of low molecular weight components can be avoided in the process of film making (casting).

In an embodiment, the current application is different from U.S. Ser. No. 11/007,758B2 (TIPA), because TIPA disclosure has a high amount of PBAS (no grade numbers) in the skin layers for improving hydrophobicity (so to help improve moisture resistance of the core layer). Further, TIPA disclosure is only a cast sheet (for liquid packing), non-oriented. The core layer of the present invention is also very different from TIPA disclosure. The mechanical properties of the TIPA sheet are also not in the range of a food packaging film.

In an embodiment, current application demonstrates home compostable polymeric resin compositions without low molecular weight components as cap layers of a biaxially oriented compostable composite film for snack food packaging, plate-out of low molecular weight components on the surface of processing equipment can be avoided. The invented film has desirable processability, mechanical properties, improved heat scalability, and home compostability.

An embodiment relates to cap layers of a multi-layer composite film comprising a compostable polymeric core layer (B), a first cap layer (A) and a second cap layer (C).

In an embodiment, the polymeric core layer (B) comprises PLA resin, PHA resin and modifier X, wherein the core layer comprises PLA resin at amount of 20 to 80 wt %, PHA resin at an amount of 20 to 80 wt %, and modifier X at an amount of 0 to 40 wt % of the total weight of the core layer.

In an embodiment, the cap layers (A and C) comprise TUV-certified polymeric composition at an amount of at least 60 wt % of the total weight of the cap layer.

In an embodiment, wherein the PLA resin in the core layer includes semi-crystalline PLA resin, amorphous PLA resin, and PLA copolymers such as PLA-co-GA, PLA-co-3HP, and PLA-co-e-CL copolymers or mixture thereof.

In an embodiment, wherein the PHA resin in the core layer includes semi-crystalline PHA resins and amorphous PHA resins such as PHB, PHBV, PHB-co-3HV, PHB-co-3HHx, PHB-co-3HO, and PHB-co-4HHx or mixtures thereof.

In an embodiment, the modifier X comprises polymeric biopolymers such as PBS, PBSA, PCL, PBAT, and other biodegradable polymers or mixture thereof with a glass transition temperature of Tg≤60° C.

In an embodiment, the modifier X comprises additives including organic low molecular weight additives such as nucleating agent, chain extenders, slip agent, hydrolytic promoters, enzymes, plasticizers, processing aids; and non-migratory inorganic particles such as nanoclay, talc, CaCO3 or TiO2 or mixtures thereof. The additives in modifier X can be pre-compounded into either PLA resin or PHA resin.

In an embodiment, the modifier X further comprises an amount of less than 5 wt. % petroleum-based polymeric modifier with a glass transition temperature of Tg≤10° C.

In an embodiment, the first cap layer comprises TUV-certified home compostable polymeric composition at an amount of at least 60 wt. % of the total weight of the first cap layer.

In an embodiment, the TUV-certified home compostable polymeric composition in the first cap layer comprises PBSA, PHA, PCL, and PLA copolymers such as PLA-co-GA, PLA-co-3HP, and PLA-co-e-CL copolymers or mixture thereof.

In an embodiment, the first cap layer comprises non-home-compostable but industrially compostable polymeric composition at an amount of 10 to 40 wt. % of the total weight of the first cap layer.

In an embodiment, the industrial compostable polymeric composition in the first cap layer comprises PLA, PBS, and PBAT resin or mixture thereof.

In an embodiment, the first cap layer comprises non-migratory inorganic particles such as antiblocks, nanoclay, talc, CaCO3 or TiO2 or mixtures thereof at an amount of less than 20 wt. % of the total weight of the first cap layer.

In an embodiment, the first cap layer optionally comprises migratory organic additives at a small amount of less than 0.5 wt. % of the total weight of the first cap layer such as chain extender, nucleating agent, anti-oxidant, and processing aids or mixtures thereof.

In an embodiment, the inorganic and organic additives in the first cap layer do not plate out on the surface of the processing equipment, for example, in the casting of making a sheet or a film.

In an embodiment, the second cap layer has the same composition as the first cap layer.

In an embodiment, the second cap layer has a composition different from the first cap layer.

In an embodiment, the second cap layer is a heat sealant layer.

In an embodiment, the second cap layer comprises TUV-certified home compostable polymeric composition at an amount of at least 60 wt. % of the total weight of the second cap layer and PLA resin at an amount of less than 40 wt. % of the total weight of the second cap layer.

In an embodiment, the PLA resin in the second cap layer comprises semi-crystalline PLA resin, amorphous PLA resin or mixtures thereof.

In an embodiment, the PLA resin in the second cap layer preferably is amorphous PLA resin.

In an embodiment, the TUV-certified home compostable polymeric composition in the second cap layer comprises polybutylene succinate-co-adipate (PBSA), polycaprolactone (PCL), and PLA copolymers such as PLA-co-GA, PLA-co-3HP, and PLA-co-e-CL copolymers or mixtures thereof.

In an embodiment, the amount of the PCL in the second cap layer is less than 35 wt. % of the total weight of the second cap layer (heat sealant layer).

In an embodiment, the amount of the PBSA in the second cap layer is about 20 wt. % to about 95 wt. % of the total weight of the heat sealant layer.

In an embodiment, the PLA copolymers such as PLA-co-GA, PLA-co-3HP, and PLA-co-e-CL copolymers in the second cap layer is an amount of 0 wt. % to 95 wt. % of the total weight of the second cap layer.

In an embodiment, the second cap layer comprise the inorganic non-migratory and organic migratory additives as that of the first cap layer.

In an embodiment, the inorganic and organic additives in the second cap layer do not plate out on the surface of the processing equipment, for example, in the casting of making a sheet or a film.

In an embodiment, the cap layers comprise materials different from that of the core layer.

In an embodiment, the film comprises a core layer, a heat sealable layer, and a non-heat scalable layer.

In an embodiment, the film comprises a core layer and cap layers which are heat sealable.

In an embodiment, wherein the film optionally comprises either one or two tie-layers which is located between the core layer and the two cap layers.

In an embodiment, the cap layer is either a layer of receiving print ink, metal deposition or barrier coating.

In an embodiment, the film is made by coextrusion and casting or blown process.

In an embodiment, the film is either non-oriented, or oriented in machine direction (MD), or oriented in both machine direction (MD) and transverse direction (TD).

In an embodiment, the cap layers comprise an amount of antiblock particles with a spherical size of about 2 to 6 μm.

In an embodiment, a loading of the antiblock particles in the outer skin layers is in the range of 100 to 5000 ppm of a total weight of the cap layer.

In an embodiment, a thickness of the film is about 10 μm to about 100 μm.

In an embodiment, the thickness of the film is about 15 μm to about 30 μm.

In an embodiment, the cap layers of the film have a thickness of about 1 μm to about 5 μm.

In an embodiment, the cap layers of the film have a thickness of about 1 μm to about 3 μm.

In an embodiment, the cap layers of the film have a thickness of about 1 μm to about 2 μm.

In an embodiment, the transesterification between components is achieved by processing conditions including temperature profiles, pre-compounding, and screw designs.

In an embodiment, discloses the method of making home compostable composite film with two cap layers without plate-out on the surface of the processing equipment.

In an embodiment, the invention provides a method of making home compostable composite film for food packaging which has improved home compostability in all layers.

In an embodiment, the invention provides a packaging film feasible for printing, coating, and metallization.

In an embodiment, the present invention provides a method to make a home compostable composite film using polymeric modifiers to improve the processability, mechanical properties, heat scaling properties and home compostability of a packaging film.

### BRIEF DESCRIPTION OF THE FIGURES

The foregoing and other objects, features, and advantages of the invention will be apparent from the following more particular description of preferred embodiments of the invention, as illustrated in the accompanying drawings in which like parts are referred to by the same reference characters across different views. The drawings are not necessarily to scale, emphasis instead being placed on illustrating the principles of the invention.

FIG. 1 shows the heat seal curves of the coextruded films.

FIG. 2 shows the hot tack curves of the coextruded films.

FIG. 3 shows scope of scaling for plate-out and processability: Level 0 and 1 are acceptable; and level 2 and 3 are unacceptable.

### DETAILED DESCRIPTION

### Definitions and General Techniques

For simplicity and clarity of illustration, the figures illustrate the general manner of construction, and descriptions and details of well-known features and techniques may be omitted to avoid unnecessarily obscuring the present disclosure. Additionally, elements in the figures are not necessarily drawn to scale. For example, the dimensions of some of the elements in the figures may be exaggerated relative to other elements to help improve understanding of embodiments of the present disclosure. The same reference numerals in different figures denote the same elements.

The terms “first,” “second,” “third,” “fourth,” and the like in the description and in the claims, if any, are used for distinguishing between similar elements and not necessarily for describing a particular sequential or chronological order. It is to be understood that the terms so used are interchangeable under appropriate circumstances such that the embodiments described herein are, for example, capable of operation in sequences other than those illustrated or otherwise described herein. Furthermore, the terms “include,” and “have,” and any variations thereof, are intended to cover a non-exclusive inclusion, such that a process, method, system, article, device, or apparatus that comprises a list of elements is not necessarily limited to those elements, but may include other elements not expressly listed or inherent to such process, method, system, article, device, or apparatus.

The terms “left,” “right,” “front,” “back,” “top,” “bottom,” “over,” “under,” and the like in the description and in the claims, if any, are used for descriptive purposes and not necessarily for describing permanent relative positions. It is to be understood that the terms so used are interchangeable under appropriate circumstances such that the embodiments of the apparatus, methods, and/or articles of manufacture described herein are, for example, capable of operation in other orientations than those illustrated or otherwise described herein.

No element, act, or instruction used herein should be construed as critical or essential unless explicitly described as such. Also, as used herein, the articles “a” and “an” are intended to include items, and may be used interchangeably with “one or more.” Furthermore, as used herein, the term “set” is intended to include items (e.g., related items, unrelated items, a combination of related items, and unrelated items, etc.), and may be used interchangeably with “one or more”. Where only one item is intended, the term “one” or similar language is used. Also, as used herein, the terms “has,” “have,” “having,” or the like are intended to be open-ended terms. Further, the phrase “based on” is intended to mean “based, at least in part, on” unless explicitly stated otherwise.

As defined herein, two or more elements are “integral” if they are comprised of the same piece of material. As defined herein, two or more elements are “non-integral” if each is comprised of a different piece of material.

As defined herein, “approximately” or “about” can, in some embodiments, mean within plus or minus ten percent of the stated value. In other embodiments, “approximately” or “about” can mean within plus or minus five percent of the stated value. In further embodiments, “approximately” can mean within plus or minus three percent of the stated value. In yet other embodiments, “approximately” or “about” can mean within plus or minus one percent of the stated value.

The numeric values such as amount, weight, concentration as mentioned in some embodiments, are intended to include approximate variation of the mentioned value to the practical extent possible. For example: 20 could include approximate variation of 20±2, whereas value 0 can include only possible variation of less than 1.

The present invention may be embodied in other specific forms without departing from its spirit or characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

Unless otherwise defined herein, scientific and technical terms used in connection with the present invention shall have meanings that are commonly understood by those of ordinary skill in the art. Further, unless otherwise required by context, singular terms shall include pluralities and plural terms shall include the singular. Generally, nomenclatures used in connection with, and techniques of, health monitoring described herein are those well-known and commonly used in the art.

The methods and techniques of the present invention are generally performed according to conventional methods well known in the art and as described in various general and more specific references that are cited and discussed throughout the present specification unless otherwise indicated. The nomenclatures used in connection with, and the procedures and techniques of embodiments herein, and other related fields described herein are those well-known and commonly used in the art.

The following terms and phrases, unless otherwise indicated, shall be understood to have the following meanings.

“Cap layer” is defined as the outermost layer of a coextruded sheet or film. The cap layer has direct contact to the surface of the processing equipment. The cap layer has a polymeric composition different from the core layer or inner layers.

“Polymer” is a macromolecule compound prepared by polymerizing monomers of the same or different type. Polymer includes homopolymers, random copolymers, block copolymers terpolymers, tetrapolymer, and so on. “Homopolymer” is a polymer by polymerizing one monomer and has the same repeating unit in the polymer chain. “Copolymer” is a polymer derived from more than one species of monomers or comonomers. “Terpolymer” is a polymer made by polymerizing three different monomers and “Tetrapolymer” is a polymer by polymerizing four different monomers, and so on. “Random copolymer” is defined as a polymer in which the comonomers are located randomly in the polymer molecular structure.

In an embodiment, polymers could include additional additives. The polymer is interchangeable used as “resin”.

“Biaxially oriented film” is a film that is stretched in both machine and transverse directions, producing molecular chain orientation sequentially or simultaneously in two directions. A biaxially oriented film has much higher tearing strength in machine direction in comparison with a blown film which is mainly oriented in machine direction. In addition, a blown film can also have high heat shrinkage in machine direction.

“Biodegradable Bioplastics” or “Biodegradable Film” or “Compostable Composite Film” or similar refer to polymeric materials that are ‘capable of undergoing decomposition into carbon dioxide, methane, water, inorganic compounds, or biomass in which the predominant mechanism is the enzymatic action of microorganisms, that can be measured by standardized tests, in a specified period of time, reflecting available disposal condition’. In an embodiment, more than 50%, 60%, 70%, 80%, 90% of the film could be degraded by the microbial action. In an embodiment, the film could be fully degraded by the microbial action.

In an embodiment, the biodegradable film has a home composting property as described by AS 5810-2010 standard.

“Crystallinity” refers to the degree of highly organized order structure excluding the fraction of amorphous phases in a resin.

“Semi-crystalline” or “semicrystalline” refers to a polymer that exhibits highly organized and tightly packed molecular chains. “Semi-crystalline” may be simplified as “crystalline” as in comparison with “amorphous”. The crystalline regions are called spherulites and can vary in shape and size with amorphous regions existing between the crystalline regions. As a result, this highly organized molecular structure has a defined melting temperature point.

Typically, a semi-crystalline resin has a degree of crystallinity in the range of from 10 wt % to 80 wt % of the total weight of the resin.

“Amorphous resin” has a randomly ordered molecular structure which does not have a sharp melting temperature point. Such a resin often softens or solidifies as its temperature is changed to above Tg or below Tg.

“Glass transition temperature, Tg” is a thermal property associated with the long range segmental mobility of polymer chains. As the temperature increases above Tg, a resin starts softening; as the temperature drops below Tg, the resin starts solidifying. Tg governs the rigidity, toughness and flexibility of the polymer in a specific temperature range. Under ambient temperature condition, a polymer film with a Tg higher than ambient temperature, it is rigid, otherwise it is flexible as it has a Tg below ambient temperature.

“Modifier” refers to materials that are added into the resin to improve the properties of a biaxially oriented composite film such as but not limited to improving heat-scalability, mechanical strength (flexibility, modulus, tensile strength, elongation, etc.), thermal stability, biodegradability, compostability, optical properties, and surface properties and so on. In an embodiment, modifier could be added in the resin during an appropriate step of polymerization, melt compounding, dry blending and coextrusion processes at a desirable amount.

“Modifier X” is based on polymeric composition and organic and inorganic additives used to modify the core layer. Modifier X comprises biopolymers having a glass transition temperature of Tg≤60° C. It includes for example but not limited to PBS, PBSA, PCL, PBAT, and PLA copolymers such as PLA-co-GA, PLA-co-3HP, and PLA-co-ϵ-CL copolymers.

“Transesterification” refers to the conversion of one ester to another. Transesterification on polyesters (such as a blend of PLA and PHA resins or a blend of PLA and PCL resins) is a reaction to exchange the group OR″ of a polyester with the group OR′ of another polyester (OR′ and OR″ are polyester chain segments or polyester chains). The reaction occurs in the molten state at the ester bond of one polyester with or without the presence of added acid or base catalysts or metal salt catalysts and in situ produce firstly block copolymers and finally random copolymers. The reaction is a useful for blending noncompatible polyesters and is also responsible for modification effects to improve the compatibility, mechanical properties (such as toughness and modulus), biodegradability, and compostability of a biopolymer composite. For example, the home compostability of a random PLA-co-PHB or PLA-co-ϵ-CL copolymer can be greatly improved in comparison with that of PLA homopolymers.

“Compatibility and biodegradation of PLA/PHB blends” were reviewed by Arrieta et al., The review article was published in Materials (Basel), 2017 Sep. 10(9)1008 (Article: on the Use of PLA-PHB Blends for Sustainable Food Packaging Applications). PLA/PHB blends prepared by solvent casting over the range of compositions of 0 to 100% by weight for each component are immiscible, while the miscibility of PLA and PHA blend made by extrusion are improved through increasing the melt processing temperature up to 200° C. The improved miscibility was attributed to the transesterification which occurred between PLA and PHB chains and in situ produced PLA-block-PHB copolymers, compatibilizing immiscible PLA and PHB components. For the PLA/PHB blend at the proportion of 75/25, small PHB spherulites were well dispersed in amorphous PLA phase; while at the proportion of 50/50 and 25/75, crystalline PHB forms a continuous phase, PLA component forms separated sea-island phase depending the ratio of PLA/PHA components.

The PHB component in PLA/PHB blend speeds up the biodegradability of PLA component at room temperature. PHB degradation is mainly enzymatically degraded by various enzymes which are secreted by microorganisms in contact with PHB, those enzymes (including proteinase K, serine protease, lipase, esterase, and alcalase) can accelerate PLA degradation at room temperature due to the faster disintegration of PHA/PLA structure. Commonly, PLA degradation is considered to undergo a non-enzymatic but hydrolytic degradation since microorganisms associating PLA in nature cannot secret enzymes to break PLA long chains into PLA oligomers which can then be enzymatically degraded into CO₂ and H₂O. A different view was reported by Huang et al. reported (Biomacromolecules, 2020, 21, 3301-3307), proteinase K embedded in either solution-cast or extrusion-cast PLA film sample can accelerate the PLA degradation at the conditions of temperature 37° C. and pH value 8.5 in 50 mM Tris-HCL buffer (pH=8.5) solution, this enzymatic degradation forms small holes and cavities observed the surface and inside bulk of PLA film samples, characterized by SEM images and measured the weight loss of the PLA film samples.

In an embodiment, PLA/PHB blend with a higher PHB fraction associates more microorganisms and secretes more enzymes, which speeds up PLA enzymatic biodegradation under lower temperatures.

Low molecular weight molecules or components” is defined as any additives such as plasticizers, enzymes, hydrolytic promoters, slip agents, monomers, and oligomers found in a polymeric composition or materials could transfer to the surface of processing equipment or the article inside a packaging by direct contact or migration during processing or packaging.

“Non-home-compostable but industrial compostable polymeric composition” is defined as biodegradable polymers such as PLA resins which pass industrial composting test but fail in home composting test.

“Plate out” is defined as deposition of low molecular weight molecules in the forms of buildup and coated white powder on the surface of processing equipment through the direct contact or the migration of low molecular weight components. The deposition of low molecular weight components is so-called as the plate-out of the biopolymer composition, which interferes with proper operation of the equipment.

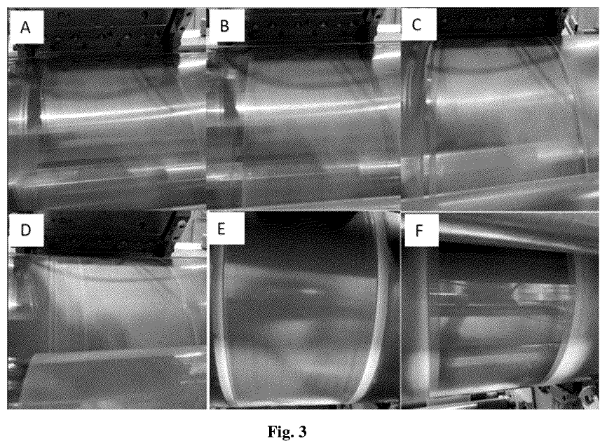

In an embodiment, a scale of 0 to 3 to address the severity of plate-out, the scope of scaling for plate-out is: Level 0 and 1 are acceptable; and level 2 and 3 are unacceptable, as shown in FIG. 3. Level 0: no obvious white particles of plate out on the surface of the first chilled drum CD1 after one hour casting (as shown in picture A of FIG. 3, without cap layer, Picture A is the rear view of the CD1. The front view of the chilled drum has cast sheet and electrical pinning bar, references were shown as in pictures E and F). Level 1: Some very light sporadic white particles can be visually seen on the surface of the first chilled drum (as shown in picture B of FIG. 3). Level 2: A very thin layer of white particles can be visually seen on the surface of the first chilled drum (as shown in picture C). Level 3: A heavy and thick layer of white particles can be visually seen on the surface of the first chilled drum (as shown in picture D, which is the rear side of the chilled drum). Picture E is the front view of level 3 plate-out without a cap layer on the first chilled drum side. Picture F is the front view of level 3 plate out with a cap layer directly contacted to the first chilled drum, the edges of the cast sheet showed heavy plate-out while the area of the cast sheet covered with cap layer showed no obvious plate-out.

TUV-certified home compostable polymer or materials: TÜV AUSTRIA (formerly Vinçotte) is a certification body authorized by European Bioplastics, it may therefore certify and award “OK COMPOST HOME” to products that pass the requirements for home compostable packaging in biodegradation, disintegration, compost quality (ecotoxicity) and chemicals (heavy metals). The test of disintegration and biodegradation is aerobic in inoculum in home composting reactor under a controlled temperature environment of 25±5° C. according to AS 5810-10 (2010) or “OK HOME COMPOST CERTIFICATION 2019 VERSION”. All test conditions are the same as that used in industrial composting test (ASTMD 6400 and ASTM D5388 (2021), test temperature 58° C.) except that the test temperature is much lower. The maximum allowed test duration for disintegration is six months. The maximum duration time for biodegradation to reach 90% absolute or relative biodegradation is 12 months.

### Materials and Properties

Polyhydroxyalkanoates (PHA) resin has a copolymer structure of poly((3HB)ₙ-CO-(mHZ)₍₁₋ₙ₎), where H=hydroxy; B=butylene; m is the position number of hydroxy group on the carbon chain of alkanoic acid (m=3 or 4 or 5); Z is the alkanoate in the copolymer (Z=Valerate (V), Hexanoate (Hx), Octanoate (O), and Decanoate (D) or mixtures thereof); n is the mole ratio of 3HB and (1−n) is the mole ratio of mHZ in the copolymer structure. Both the mole ratio (3HB/mHZ) and the structure of mHZ dominate the basic properties of PHA resins, especially, the crystallinity and melting temperature of the PHA resins. As n=1, the PHA resin is a PHB homopolymer. PHB homopolymer has a Tg of 9° C. and a melting temperature of 175 to 178° C. It is a very rigid biopolymer due to its high crystallinity. PHA resins have a Tg in the range of −44° C.≤Tg≤9° C. and a Tm of in the range of about 120 to 178° C. (Appl. Sci. 2017, 7, 242, herein reference is listed for convenience). Amorphous PHA resins comprise a high mole ratio of mHZ monomer so that the PHA copolymers has a Tg less than ≤−10° C., they are very rubbery biopolymers. Common engineering PHA biopolymers include PHB, PHBV, PHB-co-3HHx, PHB-co-4HHx, PHB-co-3HO, and PHB-co-3HD.

An example of PHBV resins include TianAn Enmat™ Y1000P, poly(3-hydroxybutyrate-co-3-hydroxyvalerate) (PHB-co-3HV or PHBV). An amount of from about 0.5 to 1 mol % 3hydroxyvaleric acid comonomer (3HV) produced form petroleum-based chemicals as a precursor was added into feedstock in fermentation process to synthesize the copolyester of PHBV. The short side chain (methyl group CH₃) of 3HV can incorporate into PHB crystals, leading to a high melting point of 175° C. and a high crystallinity (78%) according to the data obtained from the analysis of differential scanning calorimetry (DSC) experiment. PHBV has a glass transition temperature of about 2° C. and a melt flow index 8 to 15 g/10 min., and a density of 1.25 g/cm³. Y1000P is a very rigid biopolymer due to its high crystallinity. A reversed extrusion temperature profile is preferably needed for extruding the PHBV resin for the sake of preventing from significant thermal degradation, preferably, an amount of low Tm flexible biopolymers, amorphous biopolymers, and plasticizers or mixture thereof could be blended into the PHBV resin in the core layer in extrusion to facilitate PHBV melting and eliminate its thermo-mechanically induced degradation.

PHA resins with a side chain longer than three carbons are reported in the article published by Noda et. al. (book chapter: Nodax™ Class PHA Copolymers: Their Properties and Applications; Book: Plastics from Bacteria pp 237-255). The monomers with a longer chain in PHA resins include 3-hydroxyoctanoate(3HO), 3-hydroxyhexanoate(3HHx), and 3-hydroxydecanoate (3HD). Noda et. al. reported that the crystallinity of those PHA resins with longer side chain is in the range of 35 to 42% (FIG. 8 of the article); Those PHA resins listed in the art have a glass temperature of −2.5 to 2.5° C. (FIG. 9); and a melting temperature of 125 to 145° C. (FIG. 7 of the article). However, the authors also reported that those PHA resins have Young's modulus at the levels of oriented HDPE films (FIG. 12 of the article), which is much lower than that of BOPP film used in snack food packaging.

In recent practice of “End of Life”, oriented HDPE film has been noted that it is insufficient in both tensile strength and modulus to be a good packaging material to replace the current BOPP packaging materials in the market. Optimal Young's modulus for desirable food packaging needs to reach the modulus levels of BOPP films. In comparison, the crystallinity of homopolypropylene resins used in making food packaging films in the market is about in the range of 60 to 70%, which is much higher than that of PHA resins (35 to 42%) with longer side chains. In addition, the melting temperature of homopolypropylene is in the range of 160 to 170° C., which is much higher than that of PHA resins (125 to 145° C.) with longer side chain. Both the lower crystallinity and low melting temperature of flexible PHA resins (Tg is about in the same as that of homopolypropylene, about −5 to 5° C.) with longer side chain result in lower heat resistance and higher heat shrinkage.

Optimal tensile strength and Young's modulus are required for snack food packaging. The tensile strength and stiffness/flexibility of the composite film can be controlled by balancing the ratio of rigid/flexible components in the core layer. As the content of rigid PHA resins such as PHB and PHBV in the core layer is more than 40 wt %, flexible biopolymers could be used as modifier in the core layer to improve the flexibility of the composite film. Reversely, the content of flexible PHA resins such as PHB-co-3HHx, PHB-co-3HD and PHB-co-3HO in the core layer is more than 40 wt %, rigid biopolymers such as PLA could be used in the core layer as modifier to improve the stiffness and modulus of the composite film.

PLA resin is considered as a rigid biopolymer which is available at large commercial scale with a relative low cost. Examples include NatureWorks Ingeo™ PLA4032D and PLA4043D or PLA2003D or Total Energies Corbion Luminy® LX575 and LX175 as well as LX530. These resins have a melt flow rate of about 4.0 g/10 min. at 190° C./2.16 Kg test condition except that the melt flow of LX530 resin is about 9 to 10 g/10 min., a crystallization temperature of about 145-170° C., a glass transition temperature of about 55-62° C., a density of about 1.25 g/cm³. PLA4032D, LX575 and LX530 has a melting point of about 163-173° C., which are more preferred crystalline PLA resins for thermal resistance application.

Ingeo™ PLA4043D and Luminy® LX175 has a melting point of about 145-152° C., lower Tm melting temperature of those PLA resins have the advantages of the capability of melting at lower extrusion temperatures as blended with biopolymers with poor thermal stability such as PHA resins. PLA resins with a Tm of about 150° C. melt earlier compared to PLA resins with a Tm of about 165° C. before PHA resin melts during extrusion, molten PLA resins can lubricate extrusion and facilitate PHA melting especially, as the PHA resins are PHB or PHBV resin having a Tm higher than 170° C. so that the extent of PHBV thermal degradation can be eliminated.

The crystallinity of commercial semi-crystalline PLA resins with a Tm in the range of 145 to 168° C. is in the range of about 35 wt % to 45 wt % by controlling the ratio of L and D enantiomers that are used in polymerization.

Amorphous PLA resins include NatureWorks Ingeo™ 4060D and TotalEnergies Corbion Luminy® LX975 and LX930. Those resins have a melt flow rate of about 4 to 6 g/10 min. at 190° C./2.16 Kg test condition except that the melt flow of LX930 resin is about 9 to 10 g/10 min., a glass transition temperature of Tg about 52-60° C. (softening temperature), heat seal initiation temperature of about 93° C., a density of about 1.24 g/cm³. Molecular weight Mw is about 180,000 g/mole. As it has been well known that there are no melting temperatures for amorphous PLA resins. As amorphous PLA resins are heated to their glass transition temperature Tg around 56° C., the PLA chains can flow, and form entanglements, which create seals (solidifying) as the PLA chains are cooled to the temperatures lower than Tg 56° C.

PLA copolymers include but not limited to lactide-rich copolymers such as poly(lactide-co-glycolide) (PLA-co-GA), poly(lactide-co-hydroxyalkanoate) (PLA-co-HA), poly(lactide-co-3hydroxypropionate) (PLA-co-3HP), and poly(lactide-co-ϵ-caprolactone) (PLA-co-ϵ-CL) copolymers, those PLA copolymers are home compostable as the molar fraction of comonomers reach a threshold for example 20 mole %. The comonomers such as glycolide, 3hydroxypropionate, and ϵ-caprolactone copolymerized with L and D enantiomers so that comonomers can be inserted into PLA backbone to improve the flexibility and compostability of PLA copolymer resins. The PLA copolymers can be either semi-crystalline or amorphous, depending on the ratio of the D, L enantiomers as well as non-lactide monomers.

In an embodiment, PLA copolymers can be random or block copolymers of poly(lactide-co-glycolide) (PLA-co-GA), poly(lactide-co-hydroxyalkanoate) (PLA-co-HA), poly(lactide-co-3hydroxypropionate) (PLA-co-3HP), and poly(lactide-co-ϵ-caprolactone) (PLA-co-ϵ-CL) copolymers. Random PLA copolymers with GA, CL and HA comonomers have improved biodegradability and home compostability according to the chemical structure since the homopolymer of GA, HA and CL are home compostable. Preferably, the molar fraction (y) of comonomers in the PLA backbone structure in the range 5 to 20 mole %. Structures of random PLA copolymers with home compostability are:

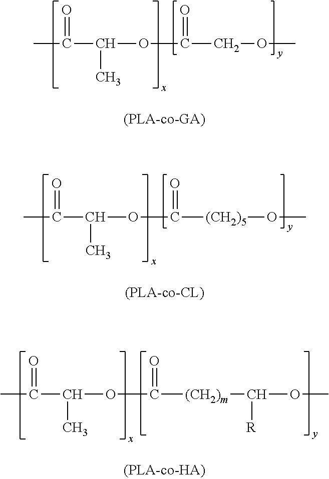

Wherein the number m in PLA-co-HA structure can be equal to 1, 2 or 3.

Low Tg flexible home compostable biopolymers include polybutylene succinate-co-adipate (PBSA) resins and polycaprolactone (PCL) resins.

One suitable example of PBSA resins could be PTT MCC BioPBS™ FD92PM, which has a glass transition temperature (Tg) −47° C. and a melting temperature (Tm) 87° C., and a melt flow index 4 grams/10 min. at 190° C./2.16 Kg standard condition. Suitable examples also include BioPBS™ FX83AC and FX85AC resins which have high melt flow index at about 15 g/10 min. and are TUV-certified for home compostable application.

One suitable example of PCL resins could be Ingevity CAPA®6500D, CAPA®6800D and CAPA®FB100, which have a glass transition temperature (Tg) about −60° C. and a melting temperature (Tm) about 58° C. and melt flow index of about 30 g/10 min. and 4.1 g/10 min. and 2 g/10 min., respectively, under 190° C./2.16 Kg test condition. Those biodegradable polymers are certified for both industrial composting and home composting by TUV Austria Group.

Poly(butylene adipate-co-butylene-terephthalate) (PBAT) resin is also a low Tg flexible biopolymer. One example of PBAT resins is BASF ecoflex® C1200, which has a density of about 1.25 g/cm³, a glass transition temperature of about −30° C. However, The PBAT melts between 50° C. and 150° C. with a flat peak at about 120° C. and has a very low crystallinity of only around 15%. a Vicat softness of about 91° C., it is a very rubbery and soft biopolymer. Ecoflex® C1200 can provide good effects on modulus reduction and sound dampening. Unfortunately, PBAT is not certified for home compostable application.

Multi-functional epoxidized or grafted maleic anhydride groups can chemically react with the chain end groups (—COOH) of polyesters. Suitable examples of multi-functional reactive polymeric resins with the functional groups include amorphous maleic anhydride modified SEBS Kraton™ FG 1924 polymer and Dow Biomax® SG 120 resin.

Kraton™ FG 1924 polymer is an amorphous elastomer having a glass transition temperature of −90° C. for its polybutadiene blocks and a Tg of 100° C. for its polystyrene blocks, the weight percentage of polystyrene blocks is only about 17 wt %. Therefore, FG 1924 is a very rubbery material with excellent flexibility for modification at a low loading amount.

Biomax SG 120 is a type of epoxidized ethylene-acrylate copolymers or terpolymers (non-biodegradable polyolefin elastomers) with contemplated structures of ethylene-n-butyl acrylate-glycidyl methacrylate, cthylene-methyl acrylate-glycidyl methacrylate, ethylene-glycidyl methacrylate, or blends thereof. This additive has a density of about 0.94 g/cm3, a melt flow rate of about 12 g/10 min. at 190° C./2.16 kg test condition, a melting point of about 72° C., and a glass transition temperature of about −55° C.

Spherical antiblocks are necessary for film making. The spherical antiblocks includes crosslinked silicone polymer such as Tospearl® grades of polymethlysilsesquioxane of nominal 2.0 and 3.0 μm sizes and sodium aluminum calcium silicates of nominal 3 μm or 5 μm in diameter (such as Mistui Silton® JC-30 and JC-50).

PLA10A is an antiblock masterbatch comprising 5 wt % Silton® JC-30 particles and 95 wt % amorphous PLA carrier resin Luminy®LX975, it was made through toll compounding.

PLA03-3 is a pre-compounded PLA-rich alloy composition with about 20 wt % polycaprolactone CAPA®6500D, 38.9 wt % LX575, 38.9 wt % LX575, 2 wt % sebacic acid, 1.2 wt % Joncryl ADR 4468 and 0.2 wt % Zn St. the composition has improved flexibility and home compostability. It was made through toll-compounding.

PLA04-2 is a masterbatch of 20 wt % sebacic acid in PLA carrier resin produced through toll-compounding.

Ecovio®F2341 is commercially available from BASF. The resin is a pre-compounded PLA-rich alloy comprising a blend of 80 wt % semicrystalline PLA/PBAT carrier resin, and about 20 wt % CaCO3 filler with a MFR of about 4.6 g/10 min. at the test conditions of 190° C. and 2.16 Kg. The resin is certified for home compostable application by TUV Austria Group.

PLA cc S742 is CaCO3 masterbatch in PLA carrier resin commercially available from Sukano. The CaCO3 in the masterbatch is about 45 wt %.

Preferably, migratory additives should not be added into the most outer cap layers of the coextruded film. However, as the issue of plate-out and migration is under control, a small desirable amount of migratory slip additives could be included in the film structure to control surface properties of a film, the slip additives include such as fatty amides (e.g. erucamide, stearamide, oleamide, etc.) or silicone oils ranging from low molecular weight oils to ultrahigh molecular weight polysiloxane gums.

### Film Structure

In an embodiment, the multilayer film is a three-layer film comprising a polymeric core layer sandwiched by two outer cap skin layers, the core layer is considered as the base layer to provide the bulk strength and mechanical properties of the composite film.

In an embodiment, the core layer (B) comprises PLA resin, PHA resin and modifier X at an amount described previously in this document.

In an embodiment, the modifier X in the core layer comprises biopolymers including PBS, PBSA, PBAT, PCL, and random PLA copolymers such as PLA-co-3HP, PLA-co-ϵ-CL and PLA-co-GA resins having a glass transition temperature of Tg≤60° C.

In an embodiment, the core layer (B) comprises a desirable amount of flexible biopolymers working together with the resins in the heat seal layer (C) to improve the SIT, hermeticity, and plateau heat seal strength.

The flexible polymer is defined as polymers with a Tg below ambient temperature. The core layer is a substrate which contains PLA, PHA and modifier X. X contains materials that can result in plate-out on the surface of processing equipment.

In an embodiment, only rigid biopolymers such as PHB, PHBV, and PLA resins in the core layer do not improve the heat seal properties regarding seal initiation temperature (SIT) and plateau seal strength.

In an embodiment, the first cap layer comprises TUV-certified home compostable polymeric composition at an amount of at least 60 wt % of the total weight of the cap layer and industrial compostable polymeric composition (non-home-compostable) at an amount of 10 to 40 wt % of the total weight of the cap layer.

In an embodiment, the second cap layer has a composition the same as the first cap layer.

In an embodiment, the second cap layer has a composition different from the first cap layer.

In an embodiment, the second cap layer is a heat sealant layer.

In an embodiment, the film comprises a core layer, a non-heat sealable layer and a heat scalable layer.

In an embodiment, the film comprises a core layer and two cap layers which are heat scalable.

In an embodiment, wherein the film optionally comprises either one or two tie-layers which is located between the core layer and the two cap layers.

In an embodiment, the cap layer is either a layer of receiving print ink, metal deposition or barrier coating.

In an embodiment, the film comprises a first outer cap skin layer (A) on the top of the core layer (B), opposite the second outer cap layer which is a heat sealable layer (C), for use as a printing layer (i.e. printing ink receiving layer) or metal receiving layer or coating receiving layer. The first outer cap skin layer (A) could only incorporate non-migratory antiblock materials to control COF and web-handling.

In an embodiment, the cap layers comprise an amount of antiblock particles with a spherical size of about 2 to 6 μm.

In an embodiment, the film is made by coextrusion and casting or blown process.

In an embodiment, the film is either non-oriented, or oriented in machine direction (MD), or oriented in both machine direction (MD) and transverse direction (TD).

In an embodiment, the first outer cap skin layer (A) is preferable to discharge-treated for lamination, metallizing, printing, or coating.

In an embodiment, the laminate film embodiments could further include a priming coating layer, a barrier coating layer, and vacuum-deposited metal layer on the discharge-treated layer's surface using the skills well known in the art.

In an embodiment, this invention provides a method of improving the casting performance of making a home compostable composite film through formulating cap layers using TUV-certified home compostable polymeric resins.

In an embodiment, such a film method and composition can prevent from plate-out of low molecular weight composition so that interruption during production such as machine shout down can be avoided.

### Film Preparation

In an embodiment in the current invention, examples were practiced on a film making line armed with a three-layer 12-inch-wide flat die for molding, two chill rolls for cooling the hot polymer melt curtain, multiple heated and sped rollers for MD orientation and a tenter frame oven for TD orientation, and in-line discharge treatment and a film winding system. The main composition either in the core layer or in the cap layers is a home compostable polymeric composite described earlier except those examples used for comparison. The multi-layer laminate sheet was coextruded at extrusion temperatures designed for each layer, and the cast and pinned—using electrostatic pinning—onto a cooling drum whose surface temperature was controlled between 15° C. and 35° C. to solidify the non-oriented laminate sheet at a casting speed of about 7 to 11 mpm (meter per minute). The non-oriented laminate sheet was stretched first in the machine direction at about 40° C. to 65° C. at a stretching ratio of about 2 to about 3.5 times the original length, using differentially heated and sped rollers and the resulting stretched sheet is heat-set at about 40-50° C. on annealing rollers and cooled at about 30-40° C. on cooling rollers to obtain a uniaxially oriented laminate sheet. The uniaxially oriented laminate sheet is then introduced into a tenter oven at a line speed of about 25 to 38 mpm and preliminarily heated between 60° C. and 75° C., and stretched in the transverse direction at a temperature of about 75 to 95° C. at a stretching ratio of about 3 to 5 times the original width and then heat-set or annealed at about 90 to 140° C., preferably about 110 to 140° C., and more preferably about 120 to 140° C. for making a film with low heat shrinkage to reduce internal stresses due to the orientation and minimize shrinkage and give a relatively thermally stable biaxially oriented sheet. TD orientation rates were adjusted by moving the transverse direction rails in or out per specified increments based on the TD infeed rail width settings and width of the incoming machine-direction oriented film. The film is relaxed by 5 to 15% in TD and then optionally be passed through an in-line corona discharge-treatment system in a controlled atmosphere as described previously to whatever desired surface energy. Typically, useful surface energy can be 36 to 50 dyne/cm. The film is then wound into a roll form through film winding equipment. The biaxially oriented film has a total thickness between 10 and 100 μm, preferably between 15 and 30 μm, and most preferably between 17.5 and 25 μm.

This invention will be better understood with reference to the following examples, which are intended to illustrate specific embodiments within the overall scope of the invention.

### Example 1

The compositions of each layer of the coextruded composite films made in Examples are shown in Table 1, 2 and 3.

TABLE 1
Core layer formulations of the coextruded composite films made in Examples (“Ex.”)

| | Core layer recipe (B)-wt % | | | | | | | |
|---|---|---|---|---|---|---|---|---|
| | | | | PLA cc | | | | CAPA- |
| Examples | PLA03-3 | LX175 | Y1000P | S742 | LX575 | LX975 | PLA04-2 | 6500D |
| Ex. 1 | | 80 | | | | | | 20 |
| Ex. 2 | 100 | | | | | | | |
| Ex. 3 | 78 | | | 22 | | | | |
| Ex. 4 | 100 | | | | | | | |
| Ex. 5 | 100 | | | | | | | |
| Ex. 6 | 100 | | | | | | | |
| Ex. 7 | | | | | 36 | 36 | 10 | 18 |
| Ex. 8 | 100 | | | | | | | |
| Ex. 9 | | 50 | 50 | | | | | |
| Ex. 10 | | 30 | 70 | | | | | |
| Ex. 11 | | 40 | 60 | | | | | |
| Ex. 12 | | 30 | 70 | | | | | |
| Ex. 13 | | 30 | 70 | | | | | |
| Ex. 14 | | 40 | 60 | | | | | |
| Ex. 15 | | 50 | 50 | | | | | |
| Ex. 16 | | 30 | 70 | | | | | |

TABLE 2
1st cap layer formulations of the coextruded composite films made in Examples (“Ex.”)

| | 1^{st} cap layer recipe (A, drum side)-wt % | | | | | | | | |
|---|---|---|---|---|---|---|---|---|---|
| | | | | | | | PLA cc | | |
| Examples | PLA10A | LX175 | FD92PM | LX975 | CAPA6500D | PLA03-3 | S742 | F2341 | LX575 |
| Ex. 1 | 1 | 79 | | | 20 | | | | |
| Ex. 2 | 0.6 | | | | | 99.4 | | | |
| Ex. 3 | | | | | | 78 | 22 | | |
| Ex. 4 | 6 | | | 94 | | | | | |
| Ex. 5 | | | | | | | | 100 | |
| Ex. 6 | 6 | 24 | 70 | | | | | | |
| Ex. 7 | 1 | | 70 | | | | | | 29 |
| Ex. 8 | 6 | | 50 | 24 | 20 | | | | |
| Ex. 9 | 1 | 99 | | | | | | | |
| Ex. 10 | 1 | 99 | | | | | | | |
| Ex. 11 | 1 | 99 | | | | | | | |
| Ex. 12 | 6 | 24 | 70 | | | | | | |
| Ex. 13 | 6 | 24 | 70 | | | | | | |
| Ex. 14 | 6 | | 70 | 24 | | | | | |
| Ex. 15 | 6 | | 60 | 24 | 10 | | | | |
| Ex. 16 | 6 | | 60 | 24 | 10 | | | | |

TABLE 3
2nd cap layer formulations of the coextruded composite films made in Examples (“Ex.”)

| | 2^{nd} cap layer recipe (C, air side)- wt % | | | | | | | |
|---|---|---|---|---|---|---|---|---|
| | | | | | | PLA cc | | |
| Examples | PLA10A | LX975 | CAPA6500D | FD92PM | PLA03-3 | S742 | F2341 | LX175 |
| Ex. 1 | 6 | 74 | 20 | | | | | |
| Ex. 2 | 6 | 64 | 30 | | | | | |
| Ex. 3 | | | | | 78 | 22 | | |
| Ex. 4 | 6 | 64 | 10 | 20 | | | | |
| Ex. 5 | | | | | | | 100 | |
| Ex. 6 | 6 | 64 | 10 | 20 | | | | |
| Ex. 7 | 6 | 24 | 10 | 60 | | | | |
| Ex. 8 | 6 | 24 | 10 | 60 | | | | |
| Ex. 9 | 1 | | | | | | | 99 |
| Ex. 10 | 1 | | | | | | | 99 |
| Ex. 11 | 6 | 74 | 20 | | | | | |
| Ex. 12 | 6 | 24 | 10 | 60 | | | | |
| Ex. 13 | 6 | 24 | 10 | 60 | | | | |
| Ex. 14 | 6 | 24 | 10 | 60 | | | | |
| Ex. 15 | 6 | 24 | 10 | 60 | | | | |
| Ex. 16 | 6 | 24 | 10 | 60 | | | | |

TABLE 4
The plate-out, orientation ratio, heat set temperature, and TD relaxation

| | Plate-out on | | | Cast | | | Heat | TD |
|---|---|---|---|---|---|---|---|---|
| | | | CD1/cast | sheet | Oreintation ratio | | set | Relax. |
| Examples | CD1 | CD2 | edges | stiffness | MD | TD | ° C. | % |
| Ex. 1 | No | No | No | Good | 2.8 | 5 | 141 | 10 |
| Ex. 2 | Heavy | some | heavey | Good | 3.3 | 4.75 | 138 | 10 |
| Ex. 3 | Heavy | some | heavey | Good | 3.3 | 3.3 | 138 | 10 |
| Ex. 4 | No | No | heavey | Good | 3.3 | 4.5 | 138 | 10 |
| Ex. 5 | No | No | heavey | Good | 3.3 | 4.75 | 138 | 10 |
| Ex. 6 | No | No | heavey | Good | 2.5 | 5 | 127 | 10 |
| Ex. 7 | No | No | heavey | Good | 3.3 | 4.5 | 138 | 10 |
| Ex. 8 | No | No | heavey | Good | 3.3 | 4.75 | 138 | 10 |
| Ex. 9 | No | No | very light | Good | 2.8 | 4.5 | 104 | 10 |
| Ex. 10 | No | No | light | Rubbery | 2.8 | 4.5 | 104 | 10 |
| Ex. 11 | No | No | very light | Soft | 2.5 | 4 | 127 | 10 |
| Ex. 12 | No | No | very light | Good | 2.5 | 4.5 | 127 | 10 |
| Ex. 13 | No | No | light | Rubbery | 2.5 | 4.5 | 104 | 10 |
| Ex. 14 | No | No | very light | Soft | 2.8 | 4.5 | 138 | 10 |
| Ex. 15 | No | No | very light | Good | 2.5 | 4 | 127 | 10 |
| Ex. 16 | No | No | light | Rubbery | 2.8 | 4.5 | 104 | 10 |

TABLE 5
Plate count scale level in the Examples (“Ex.”)

| | Plate-out scale level* | | |
|---|---|---|---|
| Examples | CD1 | CD2 | CD1/cast edges |
| Ex. 1 | 0 | 0 | 0 |
| Ex. 2 | 3 | 2 | 3 |
| Ex. 3 | 3 | 2 | 3 |
| Ex. 4 | 0 | 0 | 3 |
| Ex. 5 | 2 | 1 | 2 |
| Ex. 6 | 0 | 0 | 3 |
| Ex. 7 | 0 | 0 | 3 |
| Ex. 8 | 0 | 0 | 3 |
| Ex. 9 | 0 | 0 | 0 |
| Ex. 10 | 0 | 0 | 1 |
| Ex. 11 | 0 | 0 | 0 |
| Ex. 12 | 0 | 0 | 0 |
| Ex. 13 | 0 | 0 | 1 |
| Ex. 14 | 0 | 0 | 0 |
| Ex. 15 | 0 | 0 | 0 |
| Ex. 16 | 0 | 0 | 1 |

*Level 0 and 1 are acceptable; and level 2 and 3 are unacceptable.

A three-layer coextruded biaxially oriented composite film was made as control using processes of coextrusion, casting and sequential orientation on a 12-inch-wide flat die line as described previously, including non-heat sealable layer (A), a core layer (B), a heat sealable layer (C). Each layer of the composite film was modified with 20 wt % flexible polymer CAPA6500D resin (shown in Table 1). The core layer was sandwiched between two cap skin layers. The JC-30 antiblock particles were added into two cap layers through PLA10A masterbatch for the purpose of COF control. The content of JC-30 particles in the first cap layer (A) is about 500 ppm and the content of JC-30 antiblock in the second cap heat seal layer (C) is about 3000 ppm.

The dry blended resins of each layer were melt coextruded individually in extruder A (first cap layer, cast side or drum side), B (core layer) and C (second cap layer, air side) at temperatures of about 204° C. The molten resins flowed through a set of screen pats and individual melt pipes set at temperature of 204° C. and then met inside the die body of a twelve-inch flat die set at temperature of 204° C., resulting in a curtain of molten resin. The resin curtain was then cast on a first chilled drum (CD1, chilled-roll 1, set at temperature about 30° C.) using an electrostatic pinner and annealed on a second chilled drum (CD2, or chilled-roll 2, set at temperature about 20° C.). The first cap layer directly contacted with the first chilled drum and the second cap layer directly contacted with the second chilled drum. No plate-out was observed on the surface of both first and second chilled drums (rolls). The formed cast sheet was stretched 2.8 times in the machine direction (MD) through rolls set at temperatures between 40° C. to 65° C. and then stretched 5.0 times in transverse direction (TD) in a tenter oven set temperatures 65-82° C. The resultant biaxially oriented film was subsequently annealed at 141° C. and then relaxed at 10% in TD, followed by discharge-treated on the surface of the non-heat sealable skin layer (A) opposite the heat sealable skin layer (C) via corona treatment. The film was then wound up in roll form. The conditions of MDX, TDX, heat set temperatures and TD relaxation were showed in Table 4.

The total thickness of this film substrate after biaxial orientation was attempted to be about 80 gauges (G) or 0.8 mil or 20 μm. The thickness of the respective heat sealable resin layer (C) after biaxial orientation was about 8 G (2.0 μm). The thickness of the core layer (B) after biaxial orientation was about 68 G (17.0 μm). The thickness of the non-scalable skin layer (A) was about 4 G (1.0 μm).

### Example 2

Example 1 was repeated while the formulations were changed. The core layer was changed to PLA03-3 composite resin; the first cap layer was changed to a blend of 99.4% PLA03-3 and 0.6 wt % PLA10A, and the second cap layer comprises 64 wt % LX975, 30 wt % CAPA6500D and 6 wt % PLA10A. The first cap layer side of molten polymer curtain was cast on CD1 set 30° C. to form a cast sheet and then the opposite side was annealed on CD2. The sheet was then oriented in machine direction for 3.3 times and then in transverse direction for 4.75 times. The composite film was heat set at 138° C. and relaxed for 10% in TD and then corona-treated under conditions described previously. Heavy plate-out (white powder) was observed on both CD1 after about one hour of casting time, no buildup was observed on CD2. After conducting chemical analysis on the white powder collected from CD1, the white powder was identified as a majority of sebacic acid, which was added into the PLA03-3 composite as a hydrolytic promoter of PLA resin to improve home compostability.

### Example 3

Example 3 was changed to make a monolayer composite film with 78 wt % PLA03-3 and 22 wt % PLA cc S742 in the film structure of all three layers. CaCO3 content in the film structure is about 10 wt %. The composite film showed opaque appearance and good cavitation in the core layer based on SEM-cross-section image. Heavy plate-out (white powder of sebacic acid) was observed on CD1 after about one hour of casting time, light buildup was observed on CD2. The white powder was identified as a majority of sebacic acid and a minority of CaCO3.

### Example 4

Example 4 was changed to make a composite film with 100 wt % PLA03-3 in the core layer and two different cap layers. The first cap layer comprises amorphous PLA resin and antiblock JC30 particles at a loading of about 3000 PPM. The second cap layer comprises a blend of 64 wt % LX975, 20 wt % FD92PM, 10 wt % CAPA6500D and 6 wt % PLA10A. Both cap layers are heat sealable but not home composable. No obvious plate-out (white powder) was observed on both CD1 and CD2 after about one hour of casting time except that light white powder buildup was observed on the drum surface with direct contact to the core layer of the coextruded sheet (area of cast sheet edges).

### Examples 5

Example 4 was repeated except that both cap layers of the coextruded film were changed to Ecovio® F2341 composite, which was certified for home compostable application, containing about 20 wt % CaCO3 and 80 wt % PLA/PBAT carrier resin. TDX was increased from 4.5 to 4.75. A small amount of plate-out (white powder) was observed on both CD1 and CD2 after about one hour of casting time. After conducting chemical analysis on the white powder collected from CD1, the white powder was identified as a majority of CaCO3 except that light white powder buildup was observed on the drum surface with direct contact to the core layer of the coextruded sheet.

### Example 6

Example 5 was repeated except that the cap layers of the coextruded film were changed to comprise 70 wt % home compostable composition to achieve home compostability. The first cap layer is non-heat sealable and the second cap layer is heat sealable. No extra migratory additives were attempted to add into both cap layers except those trace amounts of catalysts and antioxidants potentially added in the virgin resins by resin producers. No obvious plate-out (white powder) was observed on both CD1 and CD2 after about one hour of casting time except that light white powder buildup was observed on the drum surface with direct contact to the core layer of the coextruded sheet edges.

### Example 7

Example 6 was repeated, the core layer was changed to in-line dry blending using polymeric resins and a masterbatch PLA04-2 which comprises 20 wt % sebacic acid in PLA carrier resin. The LX175 resin in the first cap layer was changed to LX575 resin. The total home composable composition in both cap layers is still at 70 wt % of the total weight of each cap layer. No obvious plate-out (white powder) was observed on both CD1 and CD2 after about one hour of casting time except that light white powder buildup was observed on the drum surface with direct contact to the core layer of the coextruded sheet edges.

### Example 8

Example 6 was repeated, the cap layers were changed to two-side heat sealable composition comprising 50 wt % FD92PM, 20 wt % CAPA6500D, 24 wt % LX975 and 6 wt % PLA10A. The total home compostable composition is 70 wt % of the total weight of each cap layer. No obvious plate-out (white powder) was observed on both CD1 and CD2 after about one hour of casting time except that light white powder buildup was observed on the drum surface with direct contact to the core layer of the coextruded sheet edges.

### Example 9

Example 1 was repeated and changed to make a coextruded composite film having a core layer comprising PHA resin as majority of home compostable resin. The core layer comprises 50wt % Y1000P resin and 50 wt % LX175 resin. Y1000P is a highly crystalline PHA resin having a crystallinity of 78%, which is relatively easy to crystallize from molten polymer compared to other grades of PHA resins with higher comonomer content and longer side chain length. The two cap layers comprise 99 wt % LX175 and 1 wt % PLA10A. The cap layers are not home compostable. An optimum extrusion barrel temperature profile from the throat to end with the order of 182, 182, 190, 182, and 166° C. The die temperature was set at 171° C. The design of the extrusion temperatures was attempted to facilitate the transesterification reactions between PHBV and PLA resins and in the meantime to eliminate PHA thermal degradation during extrusion. The melt temperature of the extruder B was controlled at not higher than 165° C., at which thermal degradation observed for PHA resins starts. The extrusion temperatures of extruder A and C were higher than that of extruder B. The temperature of the die body was set at about 171° C. Generally, the residence time of polymer melt between the entrance of the extruder B and the exit of the die body was estimated at about 5 to 10 minutes, varying with the rpm of extruder B and film thickness. A similar profile of extrusion temperatures was also applied to Examples 10 to 16 in the invention. The cast sheet edges of the coextruded composite film showed a good strength for handling and pulling. No obvious plate-out (white powder) was observed on both CD1 and CD2 after about one hour of casting time. No migratory additives such as plasticizers and slip additives were added into Y1000P, the loading of nucleating agent in Y1000P is much lower than that of other commercial PHA resins due to the characteristics of Y1000P close to a PHB homopolymer. The cast sheet of Example 4 showed good stiffness for handling and pulling.

### Example 10

Example 9 was repeated with the same cap skin layer recipes. The content of PHBV Y1000P resin in the core layer (B) was increased to about 70 wt % and the content of LX175 was reduced to about 30 wt %. Light plate-out (white powder) was observed on both CD1 and CD2 (edge area) after about one hour of casting time. The cast sheet was very rubbery compared to that of Example 9 due to Y1000P′s low Tg and low crystallization rate, compared to PLA resin. A higher loading of nucleating agent in Y1000P could be used to improve the stiffness of the coextruded sheet with 70 wt % PHBV in the core layer for better sheet handling and pulling.

### Example 11

Example 10 was repeated by changing the second cap layer into a heat sealable layer using 20 wt % CAPA6500D for SIT reduction, however, two cap layers are not home compostable. The content of Y1000P in the core layer was reduced to 60 wt %. No obvious plate-out was observed on both CD1 and CD2 after about one hour of casting time. The strength (stiffness) of the coextruded cast sheet was soft compared to that of the coextruded sheet in Example 9, cast sheet strength needs to be improved for handling and pulling.

### Examples 12

Example 11 was repeated, the two cap layers were changed to comprise 70 wt % home compostable composition and the core layer was changed to comprise 30 wt % Y1000P resin. No obvious plate-out was observed on both CD1 and CD2 after about one hour of casting time. The strength (stiffness) of the coextruded cast sheet was very good (It is similar to PLA cast sheet) due to high PLA content in the core layer.

### Example 13

Example 12 was repeated except that the core layer was changed to comprise 70 wt % Y1000P. The total film structure comprises 70 wt % home compostable composition and 30 wt % industrial compostable composition, which is considered as an amount required for passing home composting test. Light plate-out was observed on both CD1 and CD2 (edge area) after about one hour of casting time. The cast sheet was very rubbery and not good for handling and pulling.

### Example 14

Example 13 was repeated except that the core layer was changed to comprising 60 wt % Y 1000P resin, and the first cap layer changed a heat sealable layer comprising 24 wt % and 70 wt % FD92Pm and 6 wt % PLA10A. The coextruded film is a two-side heat sealable film considered home composable. No obvious plate-out was observed on both CD1 and CD2 after about one hour of casting time. The stiffness and strength of the coextruded cast sheet was soft, and it needed to improve for handling and pulling.

### Example 15

Example 14 was repeated except that the core layer was changed to comprising 50 wt % Y1000P resin and the first cap layer was changed to the recipe of the second cap layer. No obvious plate-out was observed on both CD1 and CD2 after about one hour of casting time. The stiffness and strength of the coextruded cast sheet was good for handling and pulling.

### Example 16

Example 15 was repeated except that the core layer formulation was changed to comprise 70 wt % Y1000P resin and 30 wt % LX175 resin. Light plate-out was observed on both CD1 and CD2 (edge area) after about one hour of casting time. The stiffness and strength of the coextruded cast sheet was very rubbery, it is too soft to handle and pull sheet easily.

### Film Properties

In an embodiment, biaxially oriented coextruded composite films were tested for the properties of mechanical strength, heat shrinkage, heat sealing (of some samples), optical properties and COF which are basic film properties required for snack food packaging films.

The table for mechanical properties of conventional BOPE, BOPP and BOPLA films as reference. BOPE film has low softness and tensile strength, which is the bottom line for food packaging, BOPLA film has high stiffness and modulus, which is up limit for food packaging.

The mechanical properties of BOPE in Table 6 was obtained from a biaxially oriented HDPE (density d=0.93 g/cm³) film (example G) reported in US2023/0021760A1 patent application.

The density range of HDPE is in the range of 0.93 to 0.96 g/cm³.

The higher density of HDPE, the higher tensile tress and modulus of a biaxially oriented HDPE film. However, as the density of HDPE is increased, the HDPE is very difficult to process and biaxially oriented.

TABLE 6
Mechanical properties of the coextruded films made in
Examples (“Ex.”), the mechanical properties of
BOPE, BOPP as well as BOPLA films are used as references.

| | Stress (MPa) | | Elongation (%) | | Modulus (MPa) | |
|---|---|---|---|---|---|---|
| Examples | MD | TD | MD | TD | MD | TD |
| BOPP | 115 | 234 | 176 | 30 | 1658 | 2536 |
| BOPLA | 93 | 146 | 130 | 86 | 3531 | 4346 |
| BOPE | 59 | 106 | 316 | 86 | 407 | 469 |
| Ex. 1 | 94 | 114 | 173 | 110 | 2820 | 3508 |
| Ex. 2 | 89 | 97 | 177 | 130 | 2948 | 3240 |
| Ex. 3 | 82 | 59 | 101 | 117 | 3394 | 2604 |
| Ex. 4 | 76 | 98 | 153 | 110 | 2821 | 3387 |
| Ex. 5 | 82 | 79 | 173 | 123 | 2479 | 2255 |
| Ex. 6 | 54 | 66 | 220 | 140 | 2522 | 2801 |
| Ex. 7 | 78 | 72 | 143 | 130 | 2676 | 2447 |
| Ex. 8 | 81 | 99 | 163 | 110 | 2466 | 2750 |
| Ex. 9 | 118 | 200 | 113 | 73 | 3671 | 4420 |
| Ex. 10 | 120 | 199 | 123 | 67 | 3306 | 4771 |
| Ex. 11 | 87 | 138 | 113 | 80 | 3583 | 4210 |
| Ex. 12 | 81 | 124 | 117 | 72 | 3276 | 3903 |
| Ex. 13 | 98 | 180 | 118 | 70 | 2964 | 4108 |
| Ex. 14 | 70 | 129 | 95 | 58 | 3134 | 4052 |
| Ex. 15 | 83 | 116 | 147 | 86 | 2898 | 3359 |
| Ex. 16 | 94 | 152 | 117 | 67 | 2851 | 3920 |

The coextruded films were measured for mechanical strength and tear resistance and the results were shown in Table 6. A typical BOPP film was included for comparison, which were obtained from a commercial clear BOPP film (Torayfan® YOR4/70G with a thickness of 17.5 μm made in standard BOPP production line). As expected, BOPP film showed much better mechanical properties outperforming that of biofilm samples, in particular the tensile strength and modulus of BOPP film are very suitable for snack food packaging. A typical conventional heat sealable BOPLA film (made from 100% PLA resin under about the same conditions as Example 1 except for it was annealed at 138° C.) was also used as a reference for comparing mechanical properties. The BOPLA film showed the highest modulus in both MD and TD, which is the root cause of generating high noise observed for conventional BOPLA film. The coextruded composite film of Example 1 modified with 20 wt % flexible biopolymer CAPA6500D showed a significant reduction in modulus and a significant increase in elongation. The coextruded films of Examples 2 to 8 showed significant modulus reduction due to PCL in the core layer as well as the low Tg home compostable composition in the cap layers. The coextruded composite films of Example 9 to 16 with Y1000P PHBV resin in the core layer, which is very rigid, leading to the observation of high modulus for those films. The low Tg home compostable compositions in the cap layers can reduce the tensile strength and modulus of the coextruded composite films. All coextruded composite film samples showed good elongation in both MD and TD, suggesting that proper annealing temperatures were applied in film making.

In an embodiment, all coextruded film samples in Examples showed lower moduli compared to that of BOPLA since the Tg of PHBV is only about 2° C., much lower than the Tg of PLA resin (56° C.). Low Tg flexible biopolymers such as PBSA and PCL resins added into the cap skin layers can further reduce the moduli of the composite films. The moduli of the composite films can be further reduced if it is necessary by adding an amount of 10 to 25 wt % low Tg flexible biopolymers into the core layer, suitable biopolymers include such as PBSA, PCL and PBAT, low Tm PHA resins, and amorphous PHA resins.

TABLE 7
Heat shrinkage of the biaxially oriented coextruded composite
films made in Examples (“Ex.”), the heat shrinkage
of BOPP as well as BOPLA films are used as references.

| | MD shrinkage (%) | | | TD shrinkage(%) | | |
|---|---|---|---|---|---|---|
| Examples | 80° C. | 100° C. | 120° C. | 80° C. | 100° C. | 120° C. |
| BOPP | 0 | 0 | 0 | 0 | 0 | 0 |
| BOPLA | 3 | 4 | 6 | 1 | 2 | 6 |
| Ex. 1 | 2 | 3 | 5 | 1 | 1 | 3 |
| Ex. 2 | 5 | 6 | 9 | 4 | 5 | 11 |
| Ex. 3 | 2 | 3 | 5 | 2 | 3 | 5 |
| Ex. 4 | 4 | 4 | 10 | 4 | 7 | 12 |
| Ex. 5 | 4 | 5 | 10 | 2 | 4 | 10 |
| Ex. 6 | 4 | 5 | 7 | 0 | 1 | 4 |
| Ex. 7 | 3 | 4 | 5 | 2 | 3 | 8 |
| Ex. 8 | 5 | 7 | 8 | 3 | 5 | 11 |
| Ex. 9 | 3 | 7 | 12 | 8 | 17 | 27 |
| Ex. 10 | 3 | 6 | 13 | 9 | 20 | 31 |
| Ex. 11 | 1 | 1 | 3 | 1 | 3 | 7 |
| Ex. 12 | 1 | 4 | 3 | 2 | 5 | 10 |
| Ex. 13 | 3 | 6 | 12 | 10 | 22 | 33 |
| Ex. 14 | 1 | 2 | 4 | 2 | 4 | 7 |
| Ex. 15 | 2 | 4 | 8 | 4 | 8 | 16 |
| Ex. 16 | 3 | 7 | 12 | 9 | 21 | 32 |

In an embodiment, thermal stability of the biaxially oriented coextruded composite film was determined by measuring the heat shrinkage of the composite films made in Examples 1 to 16at three temperatures 80° C., 100° C. and 120° C. for a duration time of 15 minutes as shown in Table 7 (The heat shrinkage of a BOPP film (YOR4/70G) was used herein for comparison).

Firstly, BOPP film sample showed no heat shrinkage under the same test conditions due to polypropylene's high crystallinity (about 60 wt %), high melting temperature 160 to 165° C., and high heat set temperature (about 160° C.). At the conditions of an elevated temperature about 140° C. and a duration time 15 minutes, the BOPP film (YOR4/70G) has a MD shrinkage of 4 to 8% and a TD shrinkage of about 2 to 5%. BOPLA control film also showed thermal stability better than coextruded PHA composite film. Among the processing parameters of orientation ratio, relaxation rate, and heat set temperature, the heat set temperature has the greatest influence on thermal stability for the same film formulation. The higher heat set temperature is applied to the composite film, the lower heat shrinkage can be achieved. The coextruded films of Examples 9, 10, 13 and 16 showed significantly high heat shrinkage in both MD and TD, resulted from low annealing temperature 104° C. applied to the film samples in film making process. However, for a specific resin or a composite film formulation, if the heat set temperature is over the up limit of optimal heat set temperature, the film will become very brittle, leading to film breaks in film making or downstream processes.

The core layer of the coextruded composite films Example 1 to 8 comprising semi-crystalline PLA dominated composition showed higher heat resistance. Low Tg flexible home compostable composition in cap layers also showed influence on thermal stability. The core layer of the coextruded composite films comprising semi-crystalline PHA dominated composition show lower heat resistance due to the much lower onset melting temperature of PHA crystals in film structure as well as the low Tg of PHA resins.

Preferably, to achieve good thermal stability (low heat shrinkage), the heat set temperature of making the PHA-rich composite films is in the range of from 125° C. to 140° C. If the heat set temperature is too high, the composite film will become brittle so that the composite film cold be difficult to process in film making or downstream processes. If the heat set temperature of making the PHA-rich composite films is too low, the film will have high heat shrinkage which are not suitable for the application with the processes of coating, metallizing, and lamination.

However, as a high heat shrinkage rate is a characteristic function required for film application, lower heat set temperature in the range of from 80° C. to 110° C. is preferred in film making.

TABLE 8
Optical properties and coefficient of friction of the coextruded
composite films made in Examples (“Ex.”), the optical
properties of BOPLA film is used as a reference.

| Exam- | Gloss | | Haze | COF, A/A | | COF, A/B | | COF, B/B | |
|---|---|---|---|---|---|---|---|---|---|
| ples | A/60° | B/20° | % | μs | μd | μs | μd | μs | μd |
| BOPLA | 122 | 92 | 2 | 0.46 | 0.41 | 0.64 | 0.66 | 0.56 | 0.53 |
| Ex. 1 | 89 | 35 | 6 | 0.60 | 0.63 | 0.47 | 0.58 | 0.55 | 0.61 |
| Ex. 2 | 86 | 18 | 14 | 0.35 | 0.38 | 0.40 | 0.42 | 0.41 | 0.42 |
| Ex. 3 | 24 | 3 | 103 | 0.41 | 0.36 | 0.4 | 0.42 | 0.4 | 0.42 |
| Ex. 4 | 99 | 42 | 10 | 0.46 | 0.49 | 0.45 | 0.43 | 0.36 | 0.36 |
| Ex. 5 | 26 | 3 | 59 | 0.73 | 0.54 | 0.70 | 0.52 | 0.57 | 0.48 |
| Ex. 6 | 19 | 6 | 27 | 0.63 | 0.80 | 0.45 | 0.56 | 0.48 | 0.45 |
| Ex. 7 | 49 | 9 | 28 | 0.4 | 0.27 | 0.35 | 0.3 | 0.34 | 0.34 |
| Ex. 8 | 53 | 7 | 23 | 0.56 | 0.58 | 0.57 | 0.56 | 0.53 | 0.58 |
| Ex. 9 | 107 | 68 | 28 | 0.73 | 0.68 | 0.68 | 0.67 | 0.65 | 0.64 |
| Ex. 10 | 111 | 77 | 14 | 0.67 | 0.64 | 0.66 | 0.64 | 0.64 | 0.69 |
| Ex. 11 | 96 | 30 | 47 | 0.58 | 0.59 | 0.42 | 0.50 | 0.37 | 0.42 |
| Ex. 12 | 21 | 7 | 56 | 0.60 | 0.61 | 0.55 | 0.64 | 0.62 | 0.71 |
| Ex. 13 | 57 | 7 | 41 | 0.44 | 0.50 | 0.51 | 0.61 | 0.51 | 0.59 |
| Ex. 14 | 67 | 6 | 35 | 0.79 | 0.90 | 0.71 | 0.83 | 0.54 | 0.58 |
| Ex. 15 | 42 | 8 | 35 | 0.87 | 0.96 | 0.52 | 0.63 | 0.38 | 0.41 |
| Ex. 16 | 94 | 24 | 23 | 0.77 | 0.86 | 0.70 | 0.83 | 0.69 | 0.83 |

Optical properties of the coextruded film samples are shown in Table 8.

In an embodiment, BOPLA film showed the lowest haze at about 2%, and highest gloss for both A side (cast side or drum side) and C side (sealant side or air side). The monolayer film modified with 20 wt % CAPA6500D (Ex. 1) showed significant reduction on gloss and increase on haze. The coextruded composite film samples made in Example 2 and 3 showed COF much lower than the film sample made in Example 1 is due to the influence of sebacic acid powder migrated to the surface of those two samples. All coextruded composite film showed much higher haze and lower gloss than the BOPLA film resulted from the different refractive index of the modifiers and much higher surface roughness.

The COFs of the first cap layer (cast side, A side) and the second cap layer (air side, C side) of the coextruded composite film samples were measured and shown in Table 8. The “COF, A/A” is the COF of the cast side to cast side (A to A); the “COF, A/C” is the COF of cast side to air side (A to C); the “COF, C/C” is the COF of air side to air side (C to C). The COFs of the surface layers are strongly impacted by the surface hardness, tackiness, and antiblock particles (concentration and size). For a soft, tacky, and flexible skin layer, it needs a higher loading of antiblock and slip additives to meet the requirements for processing and applications. The inventive composite films in Examples showed static and dynamic COFs suitable for downstream processing and packaging film handling.

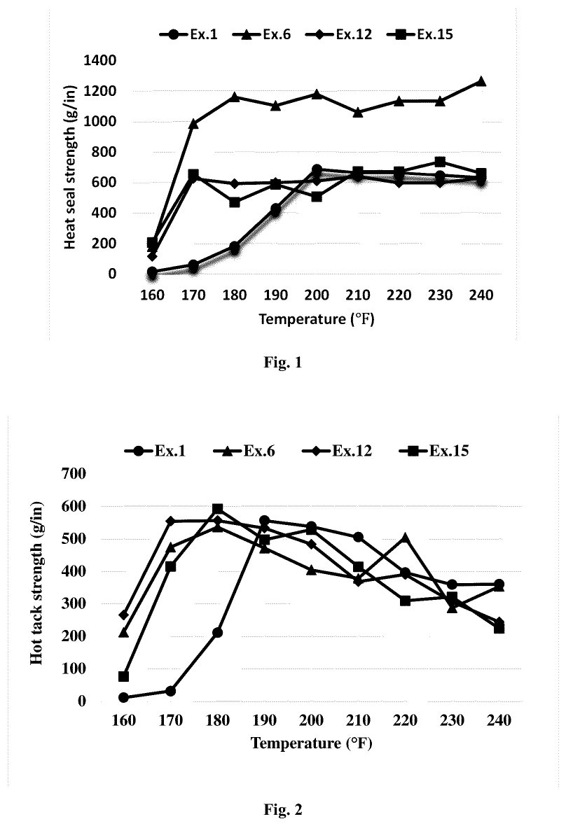

The heat seal and hot tack curves of the second cap layer (C) of the composite films in Examples 1, 6, 12, and 15 were drawn in FIGS. 1 and 2, respectively.

Example 1 (Ex.1) as shown FIG. 1 has a SIT of about 181° F. which was reduced from the SIT 193° F. of conventional BOPLA film BOPLA film. 20 wt % CAPA6500D in the heat sealant layer can significantly reduce the SIT of the coextruded composite film. In Example 6, a combination of 60 wt % FD92PM and 10 wt % CAPA6500D was used to improve both the home compostability of the cap layer as well as the heat scalability of the inner layer of a packaging bag. The SIT of the coextruded composite film was reduced to about 160° F. and the plateau seal strength was increased up to about 1100 g/in, low SIT and high seal strength will provide hermeticity in heat sealing. In comparison, the heat sealant layer of the composite films in Example 12 (with 30 wt % Y1000P in the core layer) and Example 15 (with 50 wt % Y1000P in the core layer) without flexible polymer in the core layer showed SIT comparable to that in Example 6, however, the plateau seal strength of the film samples was only about 600 g/in, much lower than that in Example 6. To improve the plateau heat seal strength, the core layer is required to have low Tg flexible polymers for high mobility from flexible polymer molecules in heat sealing process.

The hot tack SIT of the coextruded composite film in Example 1 was also higher than that of Example 6, 12 and 15, consistent with heat sealing SIT. However, there was no significant difference observed for the hot tack strength among the coextruded composite films.

Low Tg flexible biopolymers including PBSA, PCL and amorphous PHA resins as well as PHA resins with melting temperature lower than 150° C. can be added into the core layer at an amount of about 5 wt % to 25 wt % of the total weight of the core layer to further improve the hermeticity (high plateau seal strength) of the composite films.

In an embodiment, Table 9 provides a range of feasible mechanical properties of a dry food packaging film.

TABLE 9
A range of feasible mechanical properties
of a dry food packaging film.

| | Stress (MPa) | | Elongation (%) | | Modulus (MPa) | |
|---|---|---|---|---|---|---|
| Range | MD | TD | MD | TD | MD | TD |
| Up | 120 | 250 | 200 | 120 | 3000 | 4500 |
| Low | 60 | 60 | 80 | 30 | 1000 | 2000 |

### Test Methods

The various properties in the above examples were measured by the following methods:

Transparency of the film was measured by measuring the haze of a single sheet of film using a haze meter model like a BYK Gardner “Haze-Gard Plus®” substantially in accordance with ASTM D1003.

Gloss of the film was measured by measuring the desired side of a single sheet of a film by a surface reflectivity gloss meter (BYK Gardner Micro-Gloss) substantially in accordance with ASTM D2457. The A-side or non-sealable layer side was measured at a 60° angle; the sealant layer side was measured at a 20° angle.

Heat seal strength was measured using a LAKO™ Heat Sealer (model SL10) at 30 PSI, 0.5 second dwell time, and 15 second delay time before automatically testing the seal strength. The automated LAKO™ Heat Sealer is capable of forming a film seal, determining the seal strength, and generating a seal profile from a test film sample.

Hot tack strength was measured by using a LAKO™ Tool hot tack/sealer model SL10 at 30 PSI, 0.5 second dwell time, with heated flat Teflon coated lower seal jaw, and unheated upper seal jaw and with a delay time set to 0 seconds for hot tack testing.

Seal initiation temperature (SIT): SIT was measured by using the above methods (A) and (B) using the LAKO Heat Sealer or LAKO™ Tool SL10 hot tack sealer. SIT is the lowest temperature at which 200 g/in seal strength or hot tack strength is achieved.

COF of the outer skin layers of the coextruded composite films made in Examples was measured under ambient temperature condition to determine the static and dynamic COF (μs and μd) using the method of ASTM D1894.

Mechanical properties of the coextruded composite films were tested under ambient temperature condition using the method of ASTM D882.

Heat shrinkage of the coextruded composite films was measured substantially in accordance with ASTM D1204 except that the measurement condition was at three temperature levels of 80° C., 100° C. and 120° C., respectively, for a process duration time of 15 minutes.

Home compostability of the coextruded composite film is being evaluated in the home compost under the conditions specified in ASTMD5338-15 except the composting temperatures are controlled in the range 25±5° C. (AS 5810-2010 or “OK COMPOST HOME-CERTIFICATION, 2019 VERSION”).

This application discloses several numerical ranges in the text, tables and figures. The numerical ranges disclosed inherently support any range or value within the disclosed numerical ranges even though a precise range limitation is not stated verbatim in the specification because this invention can be practiced throughout the disclosed numerical ranges.

The above description is presented to enable a person skilled in the art to use the invention and is provided in the context of a particular application and its requirements. Various modifications to the preferred embodiments will be readily apparent to those skilled in the art, and the generic principles defined herein may be applied to other embodiments and applications without departing from the spirit and scope of the invention. Thus, this invention is not intended to be limited to the embodiments shown in the description but is to be accorded the widest scope consistent with the principles and features disclosed herein.

Finally, the entire disclosure of the patents and publications referred in this application are hereby incorporated herein by reference in their entirety.

1. A film having a coextruded multi-layer composite, comprising:
a core layer having a PHA resin or a PLA resin about 20 wt. % to about 80 wt. %, and a modifier X comprising a biodegradable polymer having glass transition temperature of Tg≤60° C. in an amount in a range of about 0 wt. % to about 40 wt. % of a total weight of the core layer; and at least a cap layer comprising a TUV-certified polymer in a range of at least 60 wt. % of a total weight of the cap layer;
wherein the film has a modulus in machine direction in a range of about 1000 MPa to 3000 MPa and in transverse direction in a range of about 2000 MPa to about 4500 MPa measured according to ASTM D882; and
wherein the film has plate out in a range of 0 and 1 on a scale of 0 to 3.

2. The film of claim 1, wherein the film has a top cap layer and a bottom cap layer.

3. The film of claim 1, wherein the modifier X comprises PBS, PBSA, PCL, PBAT or a mixture thereof.

4. The film of claim 1, wherein the TUV-certified polymer comprises PBSA, PHA, PCL, a PLA copolymer or a combination thereof.

5. The film of claim 4, wherein the PLA copolymer in the cap layer comprises PLA-co-GA, PLA-co-3HP, PLA-co-ϵ-CL or a combination thereof.

6. The film of claim 1, wherein the cap layer further comprises a non-home-compostable but industrial compostable polymer in an amount of about 10 wt. % to 40 wt. % of the total weight of the cap layer.

7. The film of claim 1, wherein the PLA resin comprises a semi-crystalline PLA resin, an amorphous PLA resin, a polylactide-co-glycolide (PLA-co-GA) copolymer or a mixture thereof.

8. The film of claim 1, wherein the PHA resin comprises a semi-crystalline PHA resin, or an amorphous PHA resin or a mixture thereof, wherein the amorphous PHA resin comprising PHB, PHBV, PHB-co-3HV, PHB-co-3HHx, PHB-co-3HO, PHB-co-4HHx, or a mixture thereof.

9. The film of claim 2, wherein the top cap is a non-sealable layer, and the bottom cap is a heat sealable layer.

10. The film of claim 1, wherein the film has gloss less than 120 measured at 60° angle on a non-heat sealable layer measured according to ASTM D2457.

11. The film of claim 1, wherein the modifier X further comprises a petroleum-based polymer having a glass transition temperature of Tg≤10° C. at an amount of less than 5 wt. %.

12. The film of claim 6, wherein the non-home-compostable but industrial compostable polymer comprises a PLA resin, a PBS resin, a PBAT resin or a mixture thereof.

13. The film of claim 1, wherein the cap layer comprises a non-migratory inorganic particle at an amount less than 20 wt. % of the total weight of the cap layer.

14. The film of claim 13, wherein the non-migratory inorganic particle comprises an antiblock, a nanoclay, a talc, CaCO₃ or TiO₂ or mixtures thereof.

15-20. (canceled)

21. The film of claim 1, wherein the film has a thickness of about 10 μm to about 100 μm.

22. (canceled)

23. The film of claim 1, wherein the cap layer further comprises antiblock particles in a loading in the range of 100 ppm to 5000 ppm of a total weight of the cap layer.

24. (canceled)

25. The film of claim 1, wherein a thickness of the cap layer is in a range of 1 μm to about 10 μm.

26. A method of forming a film comprising: coextruding a core layer and at least a cap layer at an extrusion temperature designed for each layer to form a coextrude film, stretching the coextrude film to form a biaxially oriented film,
wherein the biaxially oriented film comprises at least a core layer comprising a PLA resin or a PHA resin and a cap layer comprising a TUV-certified polymer in a range of at least 60 wt. % of a total weight of the cap layer; wherein the film has a modulus in machine direction in a range of about 1000 MPa to 3000 MPa and in transverse direction in a range of about 2000 MPa to about 4500 MPa measured according to ASTM D882; and wherein the film has plate out in a range of 0 and 1 on a scale of 0 to 3.

27. The film of claim 1, the core layer comprises a migratory additive.

28. The film of claim 28, wherein the migratory additive comprises a slip agent, a nucleating agent, a plasticizer, a hydrolytic promoter, an enzyme or mixtures thereof.
